(19) United States
(12) Patent Application Publication
(10) Pub. No.: US 2026/0222597 A1
(43) Pub. Date: Jul. 30, 2026

(54) A CODING METHOD OR APPARATUS BASED ON AN INDICATION OF CAMERA MOTION INFORMATION

(71) Applicant: InterDigital CE Patent Holdings, SAS, Paris (FR)

(72) Inventors: Sylvain Thiebaud, Noyal sur Vilaine (FR); Saurabh Puri, Saint-Lazare (CA); Tangi Poirier, Thorigne-Fouillard (FR)

(21) Appl. No.: 19/138,074

(22) PCT Filed: Dec. 8, 2023
(86) PCT No.: PCT/EP2023/084862

§ 371 Date: Jun. 11, 2025

(30) Foreign Application Priority Data
Dec. 12, 2022 (EP) 22306848.7

(51) Int. Cl. H04N 19/176; H04N 19/119; H04N 19/139; H04N 19/192; H04N 19/59; H04N 19/70

(52) U.S. Cl. CPC H04N 19/176; H04N 19/119; H04N 19/139; H04N 19/192; H04N 19/59; H04N 19/70

(57) ABSTRACT

At least a method and an apparatus are presented for efficiently encoding or decoding video. For example, an indication of camera motion information is associated with a block in a current image, where the current image is part of a game engine 2D rendered video. A first motion information is obtained from a game engine, where the first motion represents motion information of a sample between the current image and a reference image; a second motion information is obtained from a depth map and camera parameters provided the game engine, where the second motion information represents motion information due to camera motion between the current image and the reference image; and when the first motion information and the second motion information are close, an indication of camera motion information is associated with the block. The indication of camera motion information is utilized in the encoding or decoding of the block.

### CROSS REFERENCE TO RELATED APPLICATIONS

This application claims the benefit of European Patent Application No. 22306848.7, filed on Dec. 12, 2022, which is incorporated herein by reference in its entirety.

### TECHNICAL FIELD

At least one of the present embodiments generally relates to a method or an apparatus for video encoding or decoding, and more particularly, to a method or an apparatus comprising determining whether an indication of camera motion information is associated with a coding block.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

To obtain coding gains, modern codec standards define more and more sophisticated tools, and let the codec encoder decide the best ones to use. In the scope of cloud gaming compression, minimizing the latency is key. Although intensive computation capabilities are required in recent encoders that introduce a latency between the rendering of the game content and its coding. Existing methods for coding and decoding show some limitations in the domain of coding 2D rendered video of a game engine. Therefore, there is a need to improve the state of the art.

### SUMMARY

The drawbacks and disadvantages of the prior art are solved and addressed by the general aspects described herein.

According to a first aspect, there is provided a method. The method comprises video encoding by obtaining a coding block in a current image; determining whether an indication of camera motion information is associated with the coding block; and encoding the coding block based on the determination. For instance, the current image is part of a game engine 2D rendered video. In a particular variant, for at least one sample in the coding block of the current image to be coded in inter with respect to a reference image, a first motion information representative of motion information of the at least one sample between the current image and the reference image is obtained from a game engine; a second motion information representative of motion information due to camera motion between the current image and the reference image is obtained from a depth map and camera parameters issued from the game engine; and based on a comparison between the first motion information and the second motion information an indication of camera motion information is associated with the coding block or not.

According to another aspect, there is provided a second method. The method comprises video decoding by obtaining a coding block in a current image; decoding an indication on whether camera motion information is associated with the coding block; and decoding the coding block based on the indication.

According to another aspect, there is provided an apparatus. The apparatus comprises one or more processors, wherein the one or more processors are configured to implement the method for video encoding according to any of its variants. According to another aspect, the apparatus for video encoding comprises means for implementing the method for video decoding according to any of its variants.

According to another aspect, there is provided another apparatus. The apparatus comprises one or more processors, wherein the one or more processors are configured to implement the method for video decoding according to any of its variants. According to another aspect, the apparatus for video decoding comprises means for implementing the method for video decoding according to any of its variants.

According to another general aspect of at least one embodiment, the camera parameters are representative of a position and characteristics of a game engine virtual camera capturing an image of the game engine 2D rendered video.

According to another general aspect of at least one embodiment, a value in the depth map is representative of a depth of a sample of an image of the game engine 2D rendered video

According to another general aspect of at least one embodiment, the indication of camera motion information associated with the coding block is signaled from the encoder to the decoder.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of the video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described encoding/decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

In the drawings, examples of several embodiments are illustrated.

FIG. 1 illustrates a block diagram of an example apparatus in which various aspects of the embodiments may be implemented.

FIG. 2 illustrates a block diagram of an embodiment of video encoder in which various aspects of the embodiments may be implemented.

FIG. 3 illustrates a block diagram of an embodiment of video decoder in which various aspects of the embodiments may be implemented.

FIG. 4 illustrates an example texture frame of a video game with a corresponding depth map, horizontal motion data, and vertical motion data.

FIG. 5 illustrates an example architecture of a cloud gaming system.

FIG. 6 illustrates a generic encoding method according to a general aspect of at least one embodiment.

FIG. 7 illustrates a generic decoding method according to a general aspect of at least one embodiment.

FIG. 8 illustrates an exemplary Camera Motion block segmentation example in VTM

FIG. 9 illustrates an encoding method according to a general aspect of at least one embodiment.

FIG. 10 illustrates principles of a pinhole camera model of a virtual camera in a cloud gaming system.

FIG. 11 illustrates projection planes of a virtual camera in a cloud gaming system.

FIG. 12 illustrates 2D to 3D transformations according to a general aspect of at least one embodiment.

### DETAILED DESCRIPTION

Various embodiments relate to a video coding system in which, in at least one embodiment, it is proposed to adapt video coding tools to the cloud gaming system. Different embodiments are proposed hereafter, introducing some tools modifications to increase coding efficiency and improve the codec consistency when processing 2D rendered game engine video. Amongst others, an encoding method, a decoding method, an encoding apparatus, a decoding apparatus based on this principle are proposed. Although the present embodiments are presented in the context of the cloud gaming system, they may apply to any system where a 2D video may be associated to with camera parameters, such as a video captured by mobile device along with sensor's information allowing to determine the position and characteristics of the device's camera capturing the video. Depth information may be made available either from a sensor or other processing.

Moreover, the present aspects, although describing principles related to particular drafts of VVC (Versatile Video Coding) or to HEVC (High Efficiency Video Coding) specifications, or to ECM (Enhanced Compression Model) reference software are not limited to VVC or HEVC or ECM, and can be applied, for example, to other standards and recommendations, whether pre-existing or future-developed, and extensions of any such standards and recommendations (including VVC and HEVC and ECM). Unless indicated otherwise, or technically precluded, the aspects described in this application can be used individually or in combination.

The acronyms used herein are reflecting the current state of video coding developments and thus should be considered as examples of naming that may be renamed at later stages while still representing the same techniques.

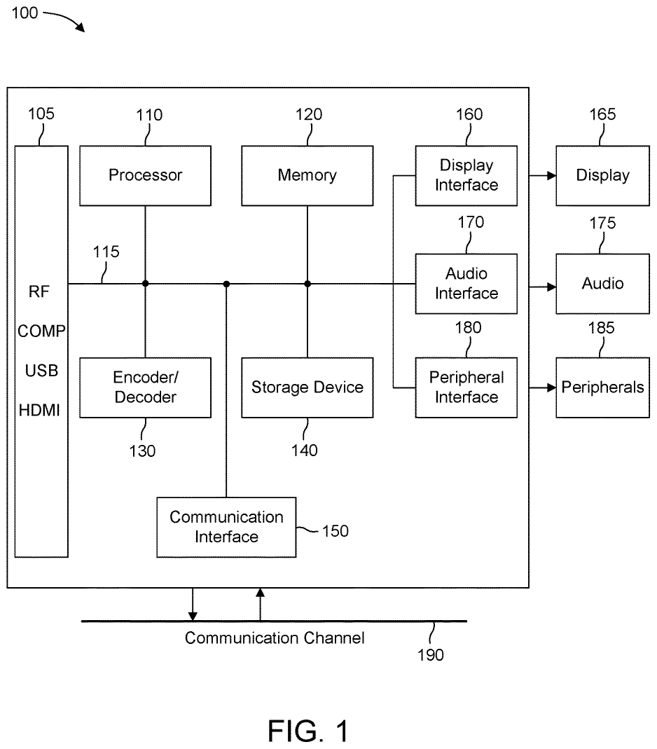

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g. a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television.

In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

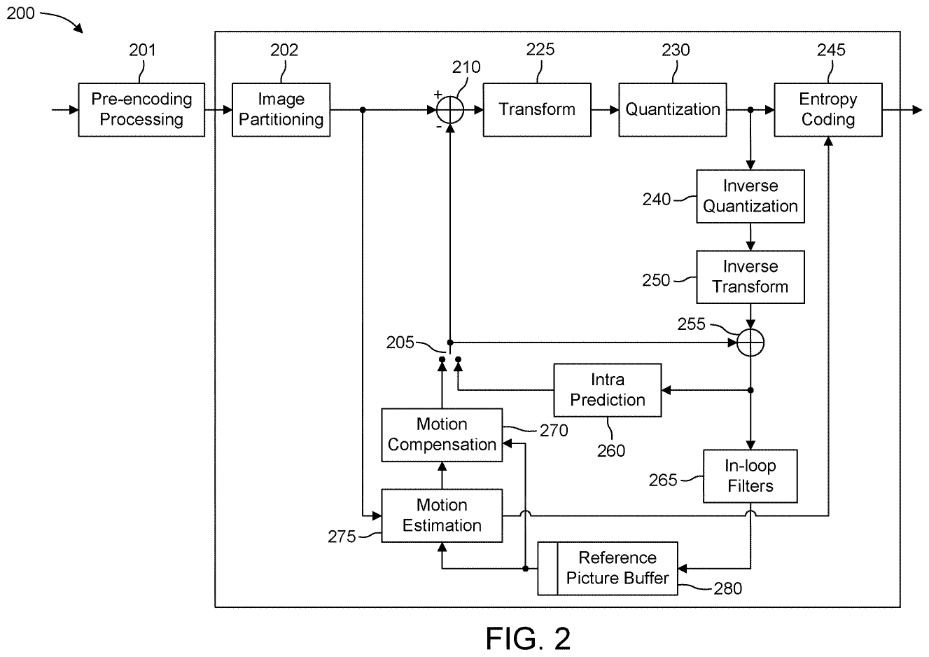

FIG. 2 illustrates an example video encoder 200, such as VVC (Versatile Video Coding) encoder. FIG. 2 may also illustrate an encoder in which improvements are made to the VVC standard or an encoder employing technologies similar to VVC.

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i. e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

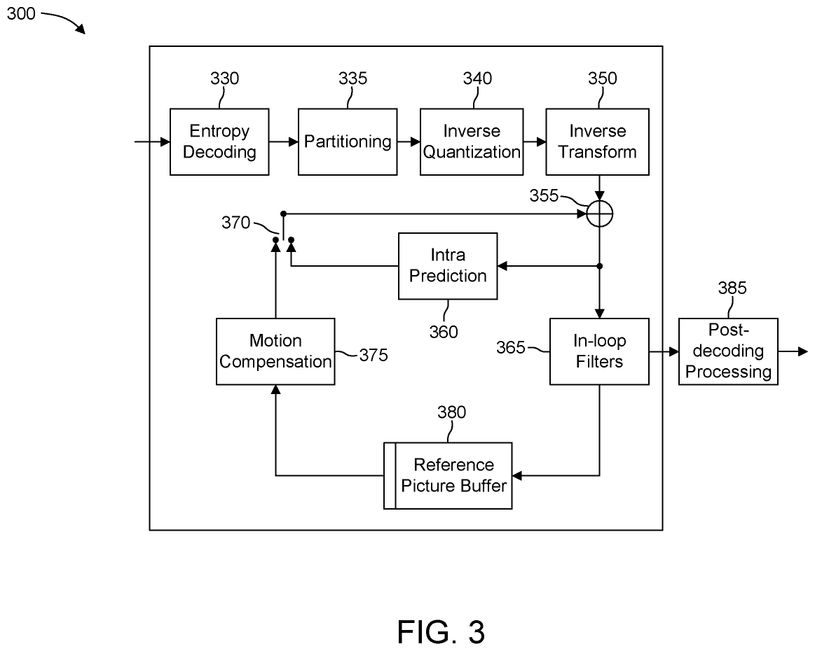

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201).

The post-decoding processing can use metadata derived in the pre-encoding processing and signaled in the bitstream.

A video coding system such as a cloud gaming server or a device with light detection and ranging (LIDAR) capabilities may receive input video frames (e.g., texture frames) together with depth information (e.g., a depth map) and/or motion information, which may be correlated.

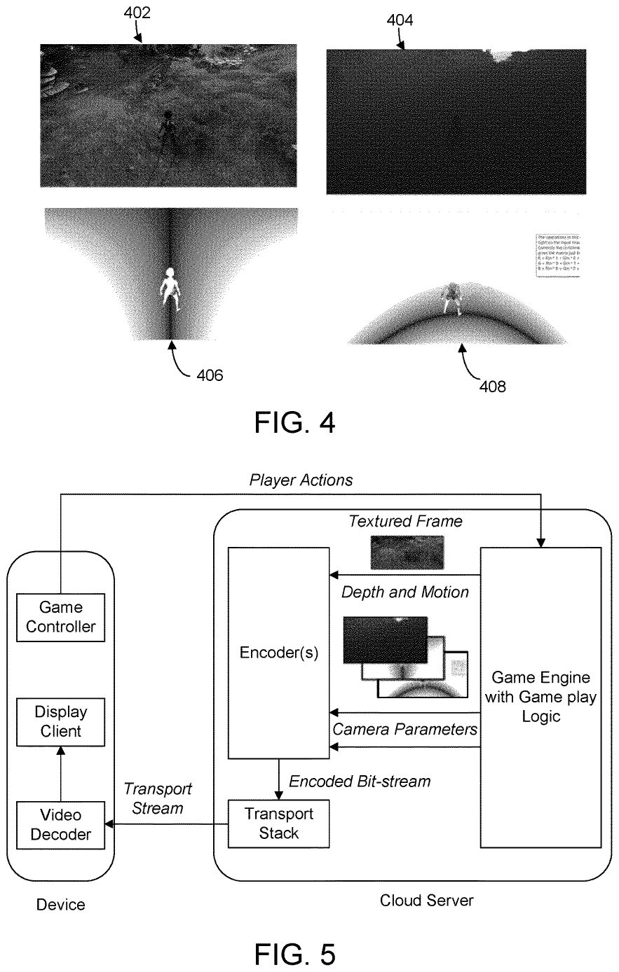

FIG. 4 illustrates an example texture frame 402 of a video game with a corresponding depth map 404, horizontal motion data 406, and vertical motion data 408 that may be extracted (e.g., directly) from a game engine that is rendering the game scene. A depth map may be represented by a grey-level image, which may indicate the distance between a camera and an actual object.

A depth map may represent the basic geometry of the captured video scene. A depth map may correspond to a texture picture of a video content and may include a dense monochrome picture of the same resolution as the luma picture. In examples, the depth map and the luma picture may be of different resolutions.

FIG. 5 shows an example architecture of a cloud gaming system, where a game engine may be running on a cloud server. The gaming system may render a game scene based on the player actions. The rendered game scene may be represented as a 2D video including a set of texture frames. The rendered game engine 2D video may be encoded into a bitstream, for example, using a video encoder. The bitstream may be encapsulated by a transport protocol and may be sent as a transport stream to the player's device. The player's device may de-encapsulate and decode the transport stream and present the decoded 2D video representing the game scene to the player. As illustrated in FIG. 5, additional information such as a depth information, motion information, an object ID, an occlusion mask, camera parameters, etc. may be obtained from a game engine (e.g., as outputs of the game engine) and made available to the cloud server (e.g., an encoder of the cloud) as prior information.

The information described herein such as the depth information, or motion information, or camera parameters or a combination thereof may be utilized to segment the rendered game engine 2D video in a video processing device (e.g., the encoder side of a video codec). The encoding decision may be simplified utilizing such segmentation of the rendered game engine 2D video while still preserving coding gains (e.g., compression gains). Accordingly, a high degree of flexibility in the block representation of a video in a compressed domain may be implemented, e.g., in a way that there may be a limited increase in a rate distortion optimization search space (e.g., on an encoder side).

At least some embodiments relate to method for encoding or decoding a video wherein, two classes of Coding Units CU (or coding blocks CB) may be used to improve motion estimation and motion compensation in inter coding. A first class of CUs comprises the Camera Motion Coding Units where the motion is only due to the movements (or characteristics) of the virtual camera of the game engine. A second class of CUs comprises the Coding Units where the motion is due to an intrinsic motion of the object in the scene (or a combination of the camera movement and the object's motion). Advantageously, this information of classification may be used by the encoder to make encoding decision and optionally transmitted to the decoder.

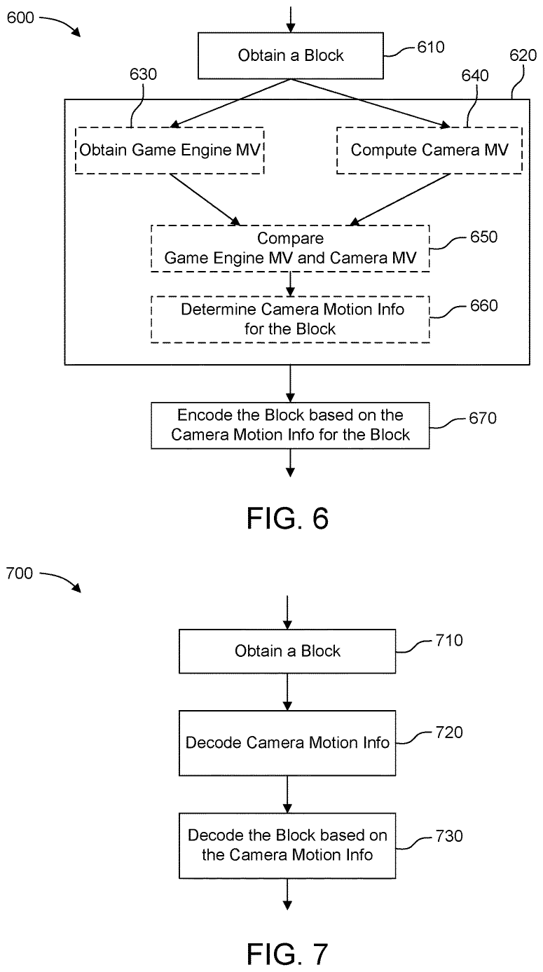

FIG. 6 illustrates a generic encoding method 600 according to a general aspect of at least one embodiment. The block diagram of FIG. 6 partially represents modules of an encoder or encoding method, for instance implemented in the exemplary encoder of FIG. 2.

According to preliminary steps not shown on FIG. 6, a game engine generates at least one image (texture image) of a 2D video, the rendered game engine 2D video, along with side information.

According to non-limiting examples, side information may comprise motion information relative to the game scene, depth information relative to game scene, or camera parameters of the virtual camera capturing the game scene. A current image of the rendered game engine 2D video is partitioned and processed in blocks (or units) of, for example, coding blocks CBs or Coding Tree units CTUs (corresponding to a higher level of image partition in a codec). Each block is encoded using, for example, either an intra or inter mode. In an inter mode, motion estimation and compensation are performed. The encoding decides which one of a plurality of inter modes to use for encoding the unit, and indicates the inter decision by, for example, signaling motion information to obtain an inter prediction block at the decoding. According to a first step 610, a coding block is obtained from a partitioning process of the current image. According to a second step 620, an indication on whether the coding block has motion information related to camera motion is determined. The determining step 620 allows to classify a current coding block of the current image into either camera motion coding block or non-camera-motion coding block using an indication (true or false) of camera motion information associated with the current coding block.

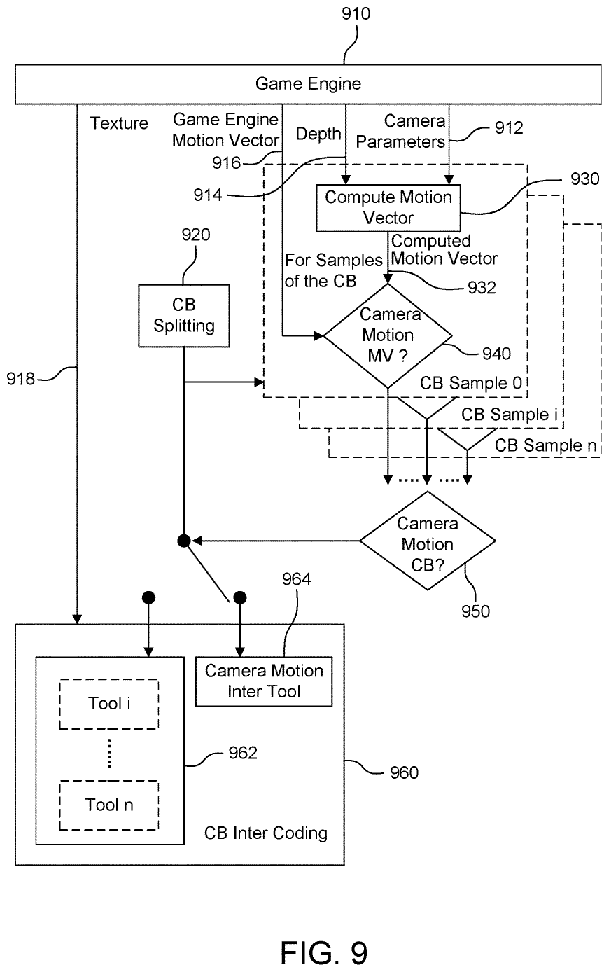

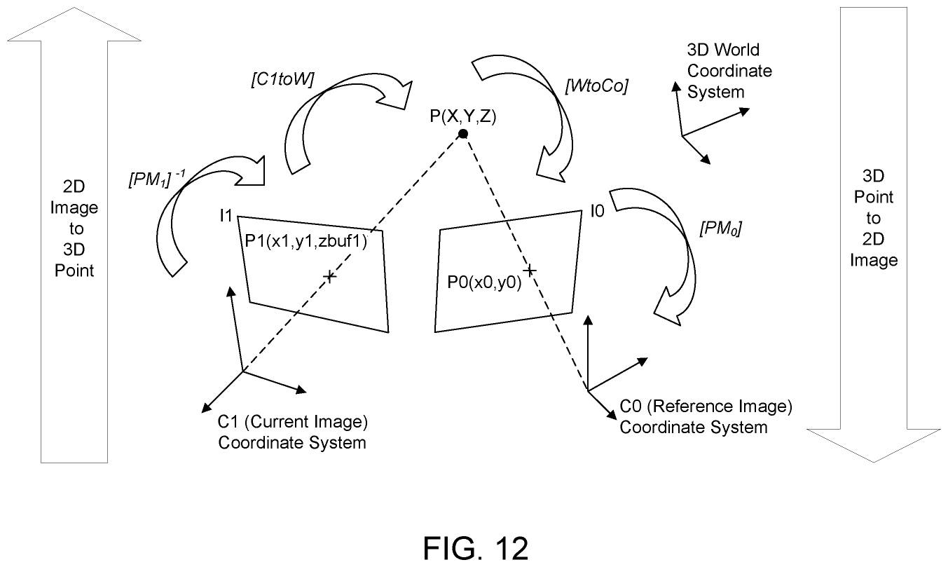

Advantageously, the indication (true or false) of camera motion information associated with the current coding block is used in the encoding process 670 to assist at least one of the partitioning process or inter prediction process. The encoding process might be speed up. According to an embodiment, the determining step 620 is based on a comparison of a sample motion information provided by the game engine and a sample motion information estimated from camera parameters of the virtual camera in the game engine along with the position of the sample of the 2D image in the 3D game scene. For example, a first motion information is obtained 630 from a game engine, the first motion information including a motion vector of a sample with respect to a reference image, Game Engine MV. The first motion information is, thus, representative of motion information of the sample between the current image and the reference image. A second motion information is obtained 640 from a depth map and camera parameters also provided by the game engine. The second motion information includes a motion vector of a sample with respect to a reference image, camera MV, and second motion information is representative of motion information of the sample due to camera motion between the current image and the reference image. A variant embodiment of the computation of second motion information is described hereafter with respect to FIG. 12. Then, in step 650, the first and second motion information are compared. A difference between camera MV and game engine MV may be computed. If the difference is above a level, meaning that camera MV and game engine MV are quite distinct, we assume that the motion of the sample is not only due to camera motion in the 3D game scene but also to the motion of the sample as part of an object. On the contrary, if the difference is below than or equal to the level, camera MV and game engine MV are close and we assume that the motion of the sample is due to camera motion in the 3D game scene. In that case, inter motion prediction might be enhanced in the encoder either using a dedicated inter motion estimation tool or by selecting only a subset of inter motion estimation tool adapted to such type of homogeneous motion. For instance, the affine motion estimation that is costly may be removed from the subset of tested inter tools as it may be redundant with camera motion estimation addressing camera motion, including rotation in 3D space. In a variant, the level of MV difference is not equal to zero, therefore coping with distortion and/or precision in the computation of the Game engine MV and/or Camera MV. In a variant, the MV difference is an absolute difference and the level of MV difference is higher than zero. According to various embodiments described hereafter with reference to FIG. 9, the MV difference is processed for one to all samples of the coding block and an indication of a camera motion information is derived at the level of the coding block. It should be highlighted that the texture information of the coding block is not used in the determination of the indication of the camera motion information which is only based on information obtained from the game engine for a defined position and size of a block. Finally, in a step 670, camera motion information associated with the coding block is used to drive the encoding decision of either partitioning process or inter encoding process of an encoding method.

According to yet another variant, a CABAC context is derived for each value of the indication of camera motion associated with the coding block in the entropy decoding process. According to another variant, the indication of camera motion information associated with the coding block is encoded and may be used at the decoding.

FIG. 7 illustrates a generic decoding method 700 according to a general aspect of at least one embodiment. The block diagram of FIG. 7 partially represents modules of a decoder or decoding method, for instance implemented in the exemplary decoder of FIG. 3. According to the first step 710, a coding block to decode is obtained in the current image. According to the second step 720, an indication on whether the coding block has motion information related to camera motion is decoded from the bitstream. In step 730, the coding block is decoded based on the indication that camera motion information is associated with the coding block. For instance, an inter prediction process adapted to camera motion content might be enabled and used to generate a prediction of the coding block. For instance, a CABAC context is derived with the determination of an indication of camera motion associated with the coding block.

### Various Embodiments of the Generic Encoding or Decoding Method are Described in the Following

According to at least one embodiment, the encoder performs the classification of blocks to code into the Camera Motion CBs and non-camera Motion CBs. Advantageously, the encoder may use this classification to make decisions. As an example, it may decide to code a Camera Motion CB with a dedicated inter prediction tool referenced herein as Camera Motion Tool. Without the information of the camera motion CBs, the encoder would have to test the performance of all the inter tools to decide which tool must be used. To obtain coding gains, modern codec standards define more and more tools, and let the encoder select the best one to use. To make this decision, intensive computation capabilities are required, introducing a latency between the rendering of the game content and its coding. Unlike offline compression, in the scope of cloud gaming compression, minimizing this latency is key. The duration between a player's action and its consequences should be minimized.

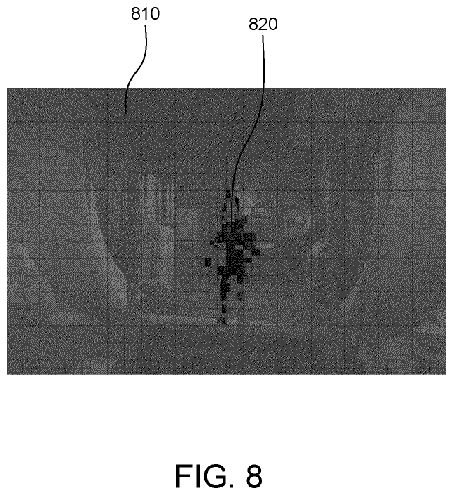

FIG. 8 illustrates an exemplary Camera Motion block segmentation example in VTM. The determination of Camera Motion block has been implemented in the VTM (the JVET reference software for VVC) on an exemplary 2D video rendered by a game engine. FIG. 8 presents the result of this implementation. The game scene represents a moving character, while the virtual camera is moving back. The encoder splits the content into Coding Blocks. By applying the determination 620 of FIG. 6 on the CBs, one can segment the coding blocks 810 of the still areas of the 3D scene where the motion is only an apparent motion due to the game engine's camera. The coding blocks 820 of the character have a proper motion, and may be coded using any of the state of the art inter motion modes (regular, affine, merge . . . ). The Camera motion CBs 810 may be processed differently than the CBs representing the moving character. For instance, a Camera Motion tool adapted to code camera motion may be applied by default to these CBs, improving the inter tool decision process, and minimizing the latency.

FIG. 9 illustrates an encoding method according to a general aspect of at least one embodiment. The game engine 910 provides a 2D rendered image 918 to the encoder. As presented above, the game engine 910 also provides the motion vectors 916, a depth map 914 and the camera parameters 912 of its virtual camera to the encoder. According to this embodiment, these 3 types of information are used to determine the Camera Motion CBs. The camera parameters 912 represent the characteristics and the position of the game engine's virtual camera. They are provided for the reference image and for the current image to be encoded. The depth information represents the depth of the 3D points of the game content for each sample (or pixel) of the current frame, after projection by the game engine's camera. Therefore, the depth information might be referred to as a depth map 914 for the current image. For the current sample, a motion vector 932 is computed by the “Compute Motion Vector” processing block 930. Since this vector is computed with the depth and the camera parameters, it represents the displacement of the current sample between the reference frame and the current frame due to a camera motion (translations and/or rotations), or a modification of the camera's characteristics (focal length, . . . ).

The game engine provides a motion vector 916 for this current sample. If this sample represents a 3D point that does not move in the 3D scene, the game engine motion vector is only due to the game engine's camera. In this case, the game engine motion vector is the same as the computed motion vector. By comparing 940 the computed motion vector 932 with the game engine's motion vector 916, one may know if this vector is only due to the camera or due to a motion in the 3D scene. In a variant, to compare the motion vectors 932 and 916, a difference between the game engine motion vector and the computed motion vector is computed for a sample in the block; and in case the MV difference is higher than a level, the motion vectors are different while in case the MV difference is lower than or equal to the level, the motion vector are considered as identical. In a variant, the MV difference is an absolute difference ending in a positive difference value.

In a variant, some errors due to computations, rounding or quantization may be considered when comparing the computed motion vector and the game engine's vector. According to this variant, the level is higher than zero.

By analyzing 950 at least one game engine motion vector of a coding block, a decision is made whether the CB is a Camera Motion CB or not (referred as a non-Camera Motion CB). Sample wise computation of motion vector and comparison with the game engine motion vector may be processed either in parallel or sequentially for the samples of a coding block. Advantageously, the processing may end as soon as a decision may be made at the level of the block.

In a variant, all samples of the CB are processed, and if one or more game engine motion vector in the coding block is different from the corresponding computed motion vector, the CB is not a Camera Motion CB. Therefore, in response to determining that for at least one sample of the block, a difference between the first motion information and the second motion information is above a level, an indication is determined that camera motion information is not associated with the coding block.

In another variant, even if a small amount of game engine motion vectors is not due to the game engine's camera, a CB might be considered as a Camera Motion CB. Accordingly, a number of non-camera-motion samples is determined in the coding block where the non-camera-motion samples have a difference between the computed motion vector and the game engine motion vector higher than the level; and in response to determining that the number of non-camera-motion samples is below a number of samples, an indication of camera motion information is associated with the coding block. In this variant, all the samples in the coding block are processed.

In this variant, the prediction of the CB by a dedicated Camera Motion tool may not be optimal but may still benefit the encoding efficiency.

In yet another variant, the CB may be sub-sampled. The motion vector computation and the comparison with the motion vectors provided by the game engine is applied to the subset of the sub-samples in the CB.

According to other variant embodiments, the indication relative to camera motion information is used to speed up the encoder. Instead of testing all the inter tools to assess their performances on the current Camera Motion CB, the encoder may decide to stop splitting 920. Thus in this variant, in response to determining that an indication of camera motion is associated with the coding block, the partitioning the coding block into smaller coding block is skipped as well as inter motion estimation process for smaller sized blocks. Besides, in this case, the encoder may decide to encode the Camera Motion CB with a dedicated Camera Motion inter tool 964. However, such Camera Motion inter tool is not in the scope of the present disclosure. In another variant, as the nature of the motion in the CB is known (camera motion), the encoder may select a subset 962 of inter coding tools in the encoding loop to speed up the encoding process. In another variant, the encoder may also further split 920 a Camera Motion CB to find an optimal partitioning while the encoder may either apply only the Camera Motion inter tool to encode the smaller partitions of the Camera Motion CB or the subset of selected inter coding tools. Advantageously, no more competition between inter tools saves encoding time.

Conversely, if some moving objects are present in the current coding block, the CB may not be well predicted by the Camera Motion inter tool. It may be encoded by another state of art inter tools. According to yet another variant, the encoder may decide to further split a non-camera motion CB to have camera motion area covered with CBs of smaller size. Therefore, in this variant, in response to determining that an indication of camera motion information is not associated with the coding block, the coding block is partitioned into smaller coding blocks and the determining whether an indication of camera motion information is iterated with a smaller coding block.

In the following, at least one embodiment of the computation of the camera motion information is detailed where the camera motion information allows to determine an indication of camera motion information associated with a coding block.

The depth map as shown in FIG. 4 and in FIG. 5 is a representation of the depth of a point belonging to the 2D projected image. However, a depth value in the depth map does not directly represents the depth of a 3D point in the 3D scene. When a 3D point is projected to a 2D image, it is projected to an image position (x,y). Indeed, mathematically a third coordinate exists, however this third coordinate is dropped when considering depth in a 2D image, but stored in the game engine's Z buffer. Advantageously, the game engine generates the third coordinate called “zbuff”. The third coordinate called “zbuff” is utilized to compute the camera motion vectors.

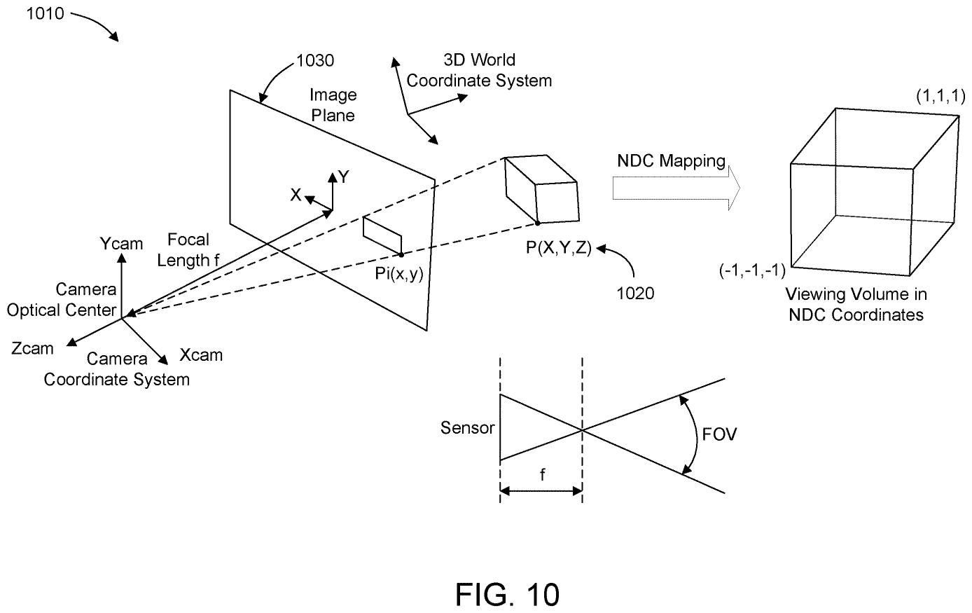

According to at least one embodiment, the video to encode is generated by 3D game engine as shown in the cloud gaming system of FIG. 5. FIG. 10 illustrates principles of a pinhole camera model of a virtual camera in a cloud gaming system. The 3D engine uses a virtual camera 1010 to project the 3D scene 1020 onto a plane 1030 to generate a 2D image. In the pinhole camera representation, the physical characteristics of the camera (focal length, sensor size, field of view, . . . ) may be used to compute a projection matrix, which is the intrinsic matrix of the camera. This matrix defines a point Pi(x,y) in the 2D image where a point P(X,Y,Z) in the 3D space is projected.

In the following, the matrix is referred to as the camera projection matrix and the 2D image as a game engine 2D rendered image.

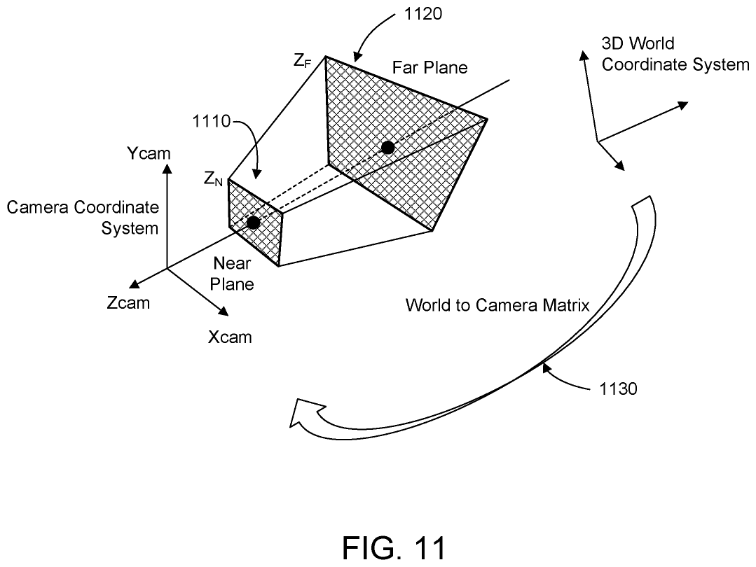

FIG. 11 illustrates projection planes of a virtual camera in a cloud gaming system. Indeed, unlike physical cameras that project objects distant from 0 to infinity, a virtual camera of a game engine projects the objects in between two projection planes: a near plane 1110 and a far plane 1120. It means that these two planes represent the minimal and maximal depth used for the rendering: the near plane 1110 is usually mapped to depth 0 and the far plane 1120 to depth 1. However, according to a variant, the depth value associated with the far and near plane may be represented conversely. The camera projection matrix depends on the position of the planes 1110, 1120. The way this matrix is built is not described here, but well known in OpenGL or

DirectX for instance. Besides, the camera projection matrix performs its projection relatively to its own coordinate system, the camera coordinate system as illustrated in FIG. 10 and FIG. 11.

Since the camera is not placed at the origin of a 3D world coordinate system, another matrix is required to convert the position of a 3D point from the 3D world coordinate system to the camera coordinate system. The world to camera matrix 1130 is utilized to represent the rotations and the translations of the camera relative to the 3D world coordinate system. The relationship between a 3D point in the game's 3D world and its 2D position in the 2D projected image is defined by the world to camera projection matrix 1130 and the camera projection matrix. Conversely, the position of a 2D image point can be linked to a 3D world point by the inverse projection matrix and the camera to world matrix. To achieve the reconstruction of a 3D world point from the 2D projected image, a third image coordinate Zbuff representing the depth value is used for each sample of 2D projected image. This is the depth information provided by the game engine, as presented in FIG. 4 and FIG. 5.

FIG. 12 illustrates 2D to 3D transformations according to a general aspect of at least one embodiment. As shown in FIG. 12, 4 matrices [PM₁]⁻¹, [C₁toW], [WtoC₀] and [PM₀] representative of a change of coordinate system or projection/deprojection are used to compute a camera motion vector. The matrices are 4×4. The world to camera matrix [WtoC₀] and the projection matrix [PM₀] characterize the camera and its position with respect to the reference image I0. The camera to world matrix [C₁toW] and the inverse projection matrix [PM₁]⁻¹ corresponds to camera in the current image I1. The zbuf1 information representing the depth of a current sample P1 is also used.

A motion vector is computed that represents the motion of the current sample P1(x1,y1) in the current image I1 relatively to a corresponding sample P0(x0,y0) in the reference image I0. In a first step, the 3D position P (X,Y,Z) of P1 in the 3D world is computed using the matrices [PM₁]⁻¹, [C₁toW] respectively characterizing the inverse projection and the camera to world matrix for the current image. In a second step, the 3D point is projected onto the reference image I0 using the matrices [WtoC₀] and [PM₀] respectively characterizing the camera C0 for the reference image and the projection in 2D reference image, the projection provides the point P0(x0,y0). The difference between the sample positions in the current image and the reference image provides the motion vector.

In a variant embodiment of the first step, the transformation of a 2D image point P1(x1,y1) of the current image to a point P in the 3D world as follows. The coordinates of the point P1(x1,y1) in the current image are expressed in Normalized Device Coordinates (NDC) in the range [−1,1].

The center of the image is [0,0]. The additional depth information zbuf1 representing the depth of the current sample P1 in the 3D scene is added as additional coordinates. The C1 inverse projection matrix [PM₁]⁻¹ and the C1 camera to world matrix [C₁toW] are applied to the 2D+1 coordinates of the point to obtain the coordinates in the 3D world. To be multiplied by the projection matrix, the 2D image point P1 must be expressed using a 4 dimensions vector in homogeneous coordinates:

$${P}_{1} = {[ {x}_{1} , {y}_{1} , zbfu 1 , 1 ]}^{T}$$

Where x₁ is an horizontal coordinate in the range [−1,1] of P1 with respect to the center of the image, y1 is a vertical coordinate in the range [−1,1] of P1 with respect to the center of the image, and zbuf1 is a depth coordinate in the range [−1,1] of P1 with respect to the 3D scene provided by the game engine. An intermediate 3D position represented by the vector [x_{cam1}, y_{cam1}, z_{cam1}, w_{cam1}]^{T} is obtained from a de-projection of P1. The inverse projection matrix [PM₁]⁻¹ of the camera C1 is applied to the vector representing P1:

$${[ {x}_{c a m 1} , {y}_{c a m 1} , {z}_{c a m 1} , {w}_{c a m 1} ]}^{T} = {[ P {M}_{1} ]}^{- 1} * {[ {x}_{1} , {y}_{1} , zbuf 1 , 1 ]}^{T}$$

To represent a real 3D cartesian position, the fourth vector coordinate w_{cam1} should be equal to 1. The four coordinates [x′_{cam1}, y′_{cam1}, z′_{cam1}, w′_{cam1}=1]^{T} are thus normalized by dividing their values by w_{cam1}:

$${[ {x}_{cam 1}^{′} , {y}_{cam 1}^{′} , {z}_{cam 1}^{′} , {w}_{cam 1}^{′} = 1 ]}^{T} = {[ \frac{{x}_{cam 1}}{{w}_{cam 1}} , \frac{{y}_{cam 1}}{{w}_{cam 1}} , \frac{{z}_{cam 1}}{{w}_{cam 1}} , \frac{{w}_{cam 1}}{{w}_{cam 1}} ]}^{T}$$

Then, the camera C1 to world matrix [C₁toW] is applied to intermediate normalized 3D cartesian position to obtain the coordinates of the 3D point [X, Y, Z, W=1] T:

$${[ X , Y , Z , W = 1 ]}^{T} = [ {C}_{1} t o W ] * {[ {x}_{cam 1}^{′} , {y}_{cam 1}^{′} , {z}_{cam 1}^{′} , {w}_{cam 1} = 1 ]}^{T}$$

In a variant embodiment of the second step, the transformation of the point P in the 3D world into a point P0(x0,y0) of the 2D reference image is obtained as follows. The world to camera C0 matrix [WtoC0] is applied to the 4 dimensions vector representing the coordinates of the 3D point P to generate an intermediate position [x_{cam0}, y_{cam0}, z_{cam0}, w_{cam0}=1]^{T}.

$${[ {x}_{c a m 0} , {y}_{c a m 0} , {z}_{c a m 0} , {w}_{c a m 0} = 1 ]}^{T} = [ W t o C 0 ] * {[ X , Z , Y , W = 1 ]}^{T}$$

Then, the projection matrix [PM₀] is applied to intermediate position to obtain the coordinates in the 2D plane of the reference image as a 4 dimensions vector [x′₀, y′₀, z′₀, w′₀]^{T}:

$${[ {x}_{0}^{′} , {y}_{0}^{′} , {z}_{0}^{′} , {w}_{0}^{′} ]}^{T} = [ {PM}_{2} ] * {[ {x}_{c a m 0} , {y}_{c a m 0} , {z}_{c a m 0} , {w}_{c a m 0} = 1 ]}^{T}$$

The fourth coordinate w is normalized to obtain the position of 2D point P0(x0, y0) in the reference image:

$${[ {x}_{0} , {y}_{0} , {z}_{0} , {w}_{0} = 1 ]}^{T} = {[ \frac{{x}_{0}^{′}}{{w}_{0}^{′}} , \frac{{y}_{0}^{′}}{{w}_{0}^{′}} , \frac{{z}_{0}^{′}}{{w}_{0}^{′}} , \frac{{w}_{0}^{′}}{{w}_{0}^{′}} ]}^{T}$$

According to yet another variant embodiment of the camera motion information computation, a motion vector is determined between P1 and P0. The motion vector MV represents the vector to applied to a position P0 of a projected 3D point in the reference image to get the corresponding position P1 of the same 3D point projected in the current image. According the MV is obtained from the difference between the coordinates of the points P1(x1, y1) and P0(x0, y0) with:

$$MV . x = x 0 - x 1 and$$

$$MV . y = y 0 - y 1.$$

According to a variant, if the motion vector provided by the game engine, Game Engine MV, is the same as the computed motion vector, it is considered as Camera Motion motion vector that is only due to a change in characteristics and/or position of the camera between the reference frame and the current frame. In another variant, some small differences may be accepted since they are due to computation, rounding or quantization errors. A threshold defining an acceptable difference between the MVs may be set, depending on the implementation.

According to another variant, the process is applied for all the pixels of the block, or after a sub sampling of the block to save processing time. In a variant, when all the motion vectors of the block are Camera Motion vectors, the block is considered as a Camera Motion block. In another variant, even if some vectors are not Camera Motion motion vectors, the block may still be a Camera Motion block. For instance, a simple threshold can define the proportion of non-Camera Motion motion vectors that can be accepted. In this case, the coding efficiency using the Camera Motion inter tool will not be optimal.

However, some motion vectors may not be Camera Motion motion vectors without introducing a strong distortion when coding the block with a dedicated Camera Motion inter tool. Conversely, a few non-Camera Motion motion vectors may imply a strong distortion when coding with the tool.

In a variant, instead of defining a threshold on the number of non-camera Motion motion vectors, a threshold on the acceptable distortion may be set.

According to another variant embodiment, the indication on whether a block is a Camera Motion block or not is signaled from the encoder to the decoder. As the original motion vectors from the game engine are only available at the encoder side, it is not possible for the decoder to determine such classification and therefore, the indication on whether a block is a Camera Motion block or not may be signaled by the encoder to the decoder.

A simple signaling strategy would be to encode a flag at block level, for example cu_camera_motion_flag in bold in the table below, to indicate whether a block is a camera motion block or not. For example, a flag is set when the block is a camera motion block.

TABLE 1
Example of Camera Motion signalling

| | Descriptor |
|---|---|
| coding_unit( x0, y0, cbWidth, cbHeight, cqtDepth, treeType, modeType ) { | |
| ...... | |
| cu_{—}camera_{—}motion_{—}flag[ x0 ][ y0 ] | ae(v) |
| cu_skip_flag[ x0 ][ y0 ] | ae(v) |
| if( cu_skip_flag[ x0 ][ y0 ] = = 0 && sh_slice_type != \| | |
| && !cu_{—}camera_{—}motion_{—}flag[ x0 ][ y0 ] | |
| && !( cbWidth = = 4 && cbHeight = = 4) && modeType = = | |
| MODE_TYPE_ALL ) | |
| pred_mode_flag | ae(v) |
| ....... | |
| if( CuPredMode[ chType ][ x0 ][ y0 ] = = MODE_INTRA \| \| | |
| CuPredMode[ chType ][ x0 ][ y0 ] = = MODE_PLT ) { | |
| if( treeType = = SINGLE_TREE \| \| treeType = = DUAL_TREE_LUMA ) { | |
| if( pred_mode_plt_flag ) | |
| palette_coding( x0, y0, cbWidth, cbHeight, treeType ) | |
| else { | |
| if( sps_bdpcm_enabled_flag && | |
| cbWidth <= MaxTsSize && cbHeight <= MaxTsSize ) | |
| intra_bdpcm_luma_flag | ae(v) |
| if( intra_bdpcm_luma_flag ) | |
| intra_bdpcm_luma_dir_flag | ae(v) |
| else { | |
| if( sps_mip_enabled_flag ) | |
| intra_mip_flag | ae(v) |
| if( intra_mip_flag ) { | |
| intra_mip_transposed_flag[ x0 ][ y0 ] | ae(v) |
| intra_mip_mode[ x0 ][ y0 ] | ae(v) |
| } else { | |
| if( sps_mrl_enabled_flag && ( ( y0 % CtbSizeY ) > 0 ) ) | |
| intra_luma_ref_idx | ae(v) |
| if( sps_isp_enabled_flag && intra_luma_ref_idx = = 0 && | |
| ( cbWidth <= MaxTbSizeY && cbHeight <= MaxTbSizeY ) && | |
| ( cbWidth * cbHeight > MinTbSizeY * MinTbSizeY ) && | |
| !cu_act_enabled_flag ) | |
| intra_subpartitions_mode_flag | ae(v) |
| if( intra_subpartitions_mode_flag = = 1 ) | |
| intra_subpartitions_split_flag | ae(v) |
| if( intra_luma_ref_idx = = 0 ) | |
| intra_luma_mpm_flag[ x0 ][ y0 ] | ae(v) |
| if( intra_luma_mpm_flag[ x0 ][ y0 ] ) { | |
| if( intra_luma_ref_idx = = 0 ) | |
| intra_luma_not_planar_flag[ x0 ][ y0 ] | ae(v) |
| if( intra_luma_not_planar_flag[ x0 ][ y0 ] ) | |
| intra_luma_mpm_idx[ x0 ][ y0 ] | ae(v) |
| } else | |
| intra_luma_mpm_remainder[ x0 ][ y0 ] | ae(v) |
| } | |
| } | |
| } | |
| } | |
| if( ( treeType = = SINGLE_TREE \| \| treeType = = DUAL_TREE_CHROMA ) | |
| && | |
| sps_chroma_format_idc != 0 ) { | |
| if( pred_mode_plt_flag && treeType = = DUAL_TREE_CHROMA ) | |
| palette_coding( x0, y0, cbWidth / SubWidthC, cbHeight / SubHeightC, | |
| treeType ) | |
| else if( !pred_mode_plt_flag ) { | |
| if( !cu_act_enabled_flag ) { | |
| if( cbWidth / SubWidthC <= MaxTsSize && cbHeight / SubHeightC | |
| <= MaxTsSize | |
| && sps_bdpcm_enabled_flag ) | |
| intra_bdpcm_chroma_flag | ae(v) |
| if( intra_bdpcm_chroma_flag ) | |
| intra_bdpcm_chroma_dir_flag | ae(v) |
| else { | |
| if( CclmEnabled ) | |
| cclm_mode_flag | ae(v) |
| if( cclm_mode_flag ) | |
| cclm_mode_idx | ae(v) |
| else | |
| intra_chroma_pred_mode | ae(v) |
| } | |
| } | |
| } | |
| } | |
| } else if( treeType != DUAL_TREE_CHROMA ) { /* MODE_INTER or | |
| MODE_IBC */ | |
| if( cu_skip_flag[ x0 ][ y0 ] = = 0 && !cu_{—}camera_{—}motion_{—}flag[ x0 ][ y0 ] ) | |
| general_merge_flag[ x0 ][ y0 ] | ae(v) |
| if( general_merge_flag[ x0 ][ y0 ] \|\| cu_{—}camera_{—}motion_{—}flag[ x0 ][ y0 ] ) | |
| merge_data( x0, y0, cbWidth, cbHeight, chType ) | |
| else if( CuPredMode[ chType ][ x0 ][ y0 ] = = MODE_IBC ) { | |
| mvd_coding( x0, y0, 0, 0 ) | |
| if( MaxNumIbcMergeCand > 1 ) | |
| mvp_l0_flag[ x0 ][ y0 ] | ae(v) |
| if( sps_amvr_enabled_flag && | |
| ( MvdL0[ x0 ][ y0 ][ 0 ] != 0 \| \| MvdL0[ x0 ][ y0 ][ 1 ] != 0 ) ) | |
| amvr_precision_idx[ x0 ][ y0 ] | ae(v) |
| } else { | |
| if( sh_slice_type = = B ) | |
| inter_pred_idc[ x0 ][ y0 ] | ae(v) |
| if( sps_affine_enabled_flag && cbWidth >= 16 && cbHeight >= 16 ) { | |
| inter_affine_flag[ x0 ][ y0 ] | ae(v) |
| if( sps_6param_affine_enabled_flag && inter_affine_flag[ x0 ][ y0 ] ) | |
| cu_affine_type_flag[ x0 ][ y0 ] | ae(v) |
| } | |
| ............ | |
| if( treeType != DUAL_TREE_CHROMA && lfnst_idx = = 0 && | |
| transform_skip_flag[ x0 ][ y0 ][ 0 ] = = 0 && Max( cbWidth, cbHeight ) | |
| <= 32 && | |
| IntraSubPartitionsSplitType = = ISP_NO_SPLIT && cu_sbt_flag = = 0 | |
| && | |
| MtsZeroOutSigCoeffFlag = = 1 && MtsDcOnly = = 0 ) { | |
| if( ( ( CuPredMode[ chType ][ x0 ][ y0 ] = = MODE_INTER && | |
| sps_explicit_mts_inter_enabled_flag ) \| \| | |
| ( CuPredMode[ chType ][ x0 ][ y0 ] = = MODE_INTRA && | |
| sps_explicit_mts_intra_enabled_flag ) ) ) | |
| mts_idx | ae(v) |
| } | |
| } | |
| } | |

According to another variant embodiment some modes are disabled if the camera_motion_flag is set to 1, as depicted in Table 1. For instance, a camera_motion_flag is coded first, and then pred_mode_flag is infer to be inter and merge flag is inferred to be equal to 1, meaning that all other modes (intra, IBC, amvp, . . . ) are disabled. In another variant, a hierarchical signaling approach is employed where, for example, a single flag is signaled for a group of blocks depicting the common characteristic i.e., when all blocks inside a group are either camera motion blocks or not. One such example is signaling the flag at a CTU level where all CU blocks under this CTU are camera motion blocks. In one such example, a flag is set at CTU level when all the blocks inside a CTU are camera motion blocks. When this flag is not set, each block inside a CTU must encode a flag indicating whether a block is camera motion block or not. Same principle may apply at the image level where in one example a flag is signaled at the image level where all CU blocks in this image are camera motion blocks.

According to another variant embodiment, the camera motion flag is decoded and used at the decoder. A camera motion flag, for example, may be used at the decoder to derive two different CABAC contexts for the coding of residual data. Depending on the camera motion flag, a different context is updated. This could be beneficial in compression efficiency since the statistics of the residuals in the camera motion region is different from the statistics of the residuals in the non-camera motion region. Although, the above approach increases the memory needed to store more CABAC tables.

### Additional Embodiments and Information

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the partitioning and inter prediction modules (202, 270, 275, 335, 375), of a video encoder 200 and decoder 300 as shown in FIG. 2 and FIG. 3. Moreover, the present aspects are not limited to VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream. Note that the syntax elements as used herein are descriptive terms. As such, they do not preclude the use of other syntax element names.

The implementations and aspects described herein may be implemented as various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
SDP (session description protocol), a format for describing multimedia communication sessions for the purposes of session announcement and session invitation, for example as described in RFCs and used in conjunction with RTP (Real-time Transport Protocol) transmission;
DASH MPD (Media Presentation Description) Descriptors, for example as used in DASH and transmitted over HTTP, a Descriptor is associated to a Representation or collection of Representations to provide additional characteristic to the content Representation;
RTP header extensions, for example as used during RTP streaming;
ISO Base Media File Format, for example as used in OMAF and using boxes which are object-oriented building blocks defined by a unique type identifier and length also known as ‘atoms’ in some specifications;
HLS (HTTP live Streaming) manifest transmitted over HTTP. A manifest can be associated, for example, to a version or collection of versions of a content to provide characteristics of the version or collection of versions.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method, comprising:
obtaining a coding block in a current image;
determining whether an indication of camera motion information is associated with the coding block; and
encoding the coding block based on the determination.

2. The method of claim 1 wherein the current image is part of a game engine two dimensional (2D) rendered video.

3. The method of claim 2 wherein the determining comprises, for at least one sample in the coding block of the current image to be coded in inter with respect to a reference image:
obtaining a first motion information from a game engine, where the first motion information is representative of motion information of the at least one sample between the current image and the reference image;
determining a second motion information from a depth map and camera parameters, where the second motion information is representative of motion information due to camera motion between the current image and the reference image; and
in response to determining that a difference between the first motion information and the second motion information is higher than a level, determining that an indication of camera motion information is not associated with the coding block.

4. The method of claim 3, wherein the level is larger than zero.

5. The method of claim 3, further comprising
determining a number of non-camera-motion samples in the coding block where the non-camera-motion samples have a difference between the first motion information and the second motion information above the level; and
in response to determining that the number of non-camera-motion samples is below a number of samples, determining that an indication of camera motion information is associated with the coding block.

6. The method of claim 3, further comprising
sub-sampling the coding block;
determining a number of non-camera-motion samples among samples of the sub-sampled coding block where the non-camera-motion samples have a difference between the first motion information and the second motion information above the level; and
in response to determining that the number of non-camera-motion samples is below a sample number, determining that an indication of camera motion information is associated with the coding block.

7. The method of claim 3, wherein the camera parameters are representative of a position and characteristics of a game engine virtual camera capturing an image of the game engine 2D rendered video.

8-9. (canceled)

10. The method of claim 3, wherein encoding the coding block further comprises in response to determining that an indication of camera motion is associated with the coding block, stopping testing partitioning the coding block into smaller coding block.

11. The method of claim 3, wherein encoding the coding block further comprises in response to determining that an indication of camera motion is not associated with the coding block, partitioning the coding block into smaller coding blocks and iterating the determining whether an indication of camera motion information is associated with a smaller coding block.

12-13. (canceled)

14. The method of claim 3, wherein determining a second motion information from a depth map and camera parameters, where the second motion information is representative of motion information due to camera motion between the current image and the reference image further comprises:
obtaining a depth value of a current sample from the depth map;
determining a three dimensional (3D) point position corresponding to the current sample in the current image based on a position of the current sample in the current image, the depth value of the current sample and on a 2D to 3D transformation specified by the camera parameters.
determining a 2D point position corresponding to a current sample in the reference image based on a 3D to 2D transformation specified by the camera parameters; and
determining the second motion information for the current sample as a displacement between a position of the current sample in the current image and a position of the current sample in the reference image.

15-16. (canceled)

17. An apparatus comprising a memory and one or more processors, wherein the one or more processors are configured to:
obtain a coding block in a current image;
determine whether an indication of camera motion information is associated with the coding block; and
encode the coding block based on the determination.

18. The apparatus of claim 17 wherein the current image is part of a game engine two dimensional (2D) rendered video.

19. The apparatus of claim 18, wherein the one or more processors are further configured, for at least one sample in the coding block of the current image to be coded in inter with respect to a reference image, to:
obtain a first motion information from a game engine, where the first motion information is representative of motion information of the at least one sample between the current image and the reference image;
determine a second motion information from a depth map and camera parameters, where the second motion information is representative of motion information due to camera motion between the current image and the reference image; and
in response to a determination that a difference between the first motion information and the second motion information is higher than a level, determine that an indication of camera motion information is not associated with the coding block.

20. The apparatus of claim 19, wherein the level is larger than zero.

21. The apparatus of claim 19, wherein the one or more processors are further configured to:
determine a number of non-camera-motion samples in the coding block where the non-camera-motion samples have a difference between the first motion information and the second motion information above the level; and
in response to determination that the number of non-camera-motion samples is below a number of samples, determine that an indication of camera motion information is associated with the coding block.

22. The apparatus of claim 19, wherein the one or more processors are further configured to:
sub-sample the coding block;
determine a number of non-camera-motion samples among samples of the sub-sampled coding block where the non-camera-motion samples have a difference between the first motion information and the second motion information above the level; and
in response to determination that the number of non-camera-motion samples is below a sample number, determine that an indication of camera motion information is associated with the coding block.

23. The apparatus of claim 19, wherein the camera parameters are representative of a position and characteristics of a game engine virtual camera capturing an image of the game engine 2D rendered video.

24-25. (canceled)

26. The apparatus of claim 19, wherein the one or more processors are further configured to stop testing partitioning the coding block into smaller coding block in response to determination that an indication of camera motion is associated with the coding block.

27. The apparatus of claim 19, wherein the one or more processors are further configured to partition the coding block into smaller coding blocks and iterate the determination of whether an indication of camera motion information is associated with a smaller coding block in response to the determination that an indication of camera motion is not associated with the coding block.

28-29. (canceled)

30. The apparatus of claim 19, wherein the one or more processors are further configured to:
obtain a depth value of a current sample from the depth map;
determine a three dimensional (3D) point position corresponding to the current sample in the current image based on a position of the current sample in the current image, the depth value of the current sample and on a 2D to 3D transformation specified by the camera parameters.
determine a 2D point position corresponding to a current sample in the reference image based on a 3D to 2D transformation specified by the camera parameters; and
determine the second motion information for the current sample as a displacement between a position of the current sample in the current image and a position of the current sample in the reference image.

31-37. (canceled)
